(19) United States
(12) Patent Application Publication
(10) Pub. No.: US 2009/0310261 A1
(43) Pub. Date: Dec. 17, 2009

(54) INFORMATION STORAGE DEVICE

(75) Inventor: Hitoshi Komoriya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/364,276

(22) Filed: Feb. 2, 2009

(30) Foreign Application Priority Data
Jun. 13, 2008 (JP) 2008-155389

(51) Int. Cl. G11B 5/54

(52) U.S. Cl. 360/254; G9B/5.181

(57) ABSTRACT

An information storage device includes: a disk-like rotatable recording medium; and a head reproducing information from and/or recording information into the recording medium. The device further includes: a fixed portion having and turns around a turning axis extending in the same direction as a rotation axis of the recording medium; and a moving portion holding the head, supported by the fixed portion, and movable relative to the fixed portion in a direction approaching and separating from the rotation axis. The device further includes: a pin fixed to and projecting from the moving portion; and a guide having a wall on which the pin abuts and slides as the moving portion turns, and restricting an orbit of the pin by a form of the wall to a predetermined orbit that extends to a leading side of the moving portion as the pin moves toward an inner periphery of the recording medium.

### CROSS-REFERENCE TO RELATED APPLICATION

This application is based upon and claims the benefit of priority of the prior Japanese Patent Application No. 2008-155389, filed on Jun. 13, 2008, the entire contents of which are incorporated herein by reference.

### FIELD

The embodiments discussed herein are related to an information storage device.

### BACKGROUND

With the development of information equipment, various information storage devices for recording a large amount of information have been developed. The information storage device is a device which stores information in a recording medium or reproduces information from the recording medium. As the recording medium, in terms of shape, a tape-like medium or a disk-like medium are used. In terms of recording or reproducing, a magnetic medium which magnetically records and reproduces information, an optical medium which optically records and reproduces information, and a magneto-optic medium which optically and magnetically records and reproduces information are known.

As the information storage device using a disk-like medium, there is known an arm-type information storage device in which a head is fixed to a leading end of an arm which turns along a disk surface, information is recorded and reproduced on and from the disk surface by the head. A HDD (Hard Disk Drive) will be described as a typical example of such a medium.

FIG. 1 illustrates a structure of the HDD.

The HDD 1 includes a magnetic disk 2 which rotates around a disk center as a rotating center, and a swing arm 3 which turns around an arm shaft as a pivot center.

The magnetic disk 2 has a large number of concentric trucks on the disk surface, and information is magnetically recorded along the trucks. Due to the constant development of the information equipment, it is a continual problem to increase the capacity and recording density of the information storage device, and it is strongly preferable to narrow a truck pitch of the magnetic disk 2.

The swing arm 3 holds a magnetic head 4 near its leading end in the vicinity of the disk surface of the magnetic disk 2, the swing arm 3 is driven and turned by an actuator 5, and the magnetic head 4 is moved along the disk surface.

The magnetic head 4 is moved by the swing arm 3 to form an arc extending along the circumference R illustrated in the drawings. Therefore, the magnetic head 4 by the inner peripheral side truck and the outer peripheral side truck have different angles (yaw angles) with respect to the truck. In the case of the example illustrated in FIG. 1, the magnetic head 4 is oriented to the extending direction of the arm, and a direction of the magnetic head 4 with respect to the tangent direction of the truck is a direction of 12° leftward of the drawing with respect to the innermost peripheral side (inner) truck Tin and a direction of 15° rightward of the drawing with respect to the outermost peripheral side (outer) truck Tout. That is, the yaw angle of the magnetic head 4 is changed by 27° in the example illustrated in the drawing by the movement in the form of the arc caused by the swing arm 3, and in a general HDD, it is known that the yaw angle is changed by about 25° to 40°.

Influence of the change of yaw angle upon the information recording into the magnetic disk 2 will be described below.

FIG. 2 illustrates a positional relation between the truck and a magnetic pole of the magnetic head.

In FIG. 2, the HDD is of a so-called vertical recording type HDD in which information is recorded on the magnetic disk by magnetization in a direction perpendicular to the disk surface, and the magnetic poles 6 of the magnetic head are illustrated with a surface shape (rectangular) facing the magnetic disk. According to the vertical recording type HDD, a magnetic pattern recorded on the magnetic disk is a pattern of a shape of the magnetic pole surface facing the magnetic disk side.

Part (A) of FIG. 2 illustrates a positional relation between trucks T and the magnetic poles 6 when the yaw angle is large. Part (B) of FIG. 2 illustrates a positional relation between the trucks T and the magnetic poles 6 when the yaw angle is 0. The moving direction of the magnetic poles 6 with respect to the truck T (i.e., a relative moving direction of the magnetic head when the magnetic disk rotates) is downward as illustrated with the arrow A in the drawing.

As illustrated in part (B) of FIG. 2, when the yaw angle is 0, the magnetic poles 6 fall in the pitch P of the truck T, but if the yaw angle is large as illustrated in part (A) of FIG. 2, the leading sides (right lower sides in the drawing) of the magnetic poles 6 protrude from the pitch P of the truck T, and information is overwritten on the adjacent trucks.

Since the yaw angle is generally changed by about 25° to 40° as the magnetic head is moved in the form of arc by the arm, such overwriting occurs somewhere on the magnetic disk. If the truck pitch is increased to avoid such overwriting, the capacity of the HDD is reduced.

To avoid the overwriting, there is known a technique for tapering the magnetic pole shape.

FIG. 3 illustrates a positional relation between the truck and tapered magnetic poles.

FIG. 3 illustrates the magnetic pole 7 as being tapered surfaces facing the magnetic disk. In FIG. 3 also, the moving direction of the magnetic poles 7 with respect to the truck T is downward as illustrated with the arrow A in the drawing.

Like FIG. 2, part (A) of FIG. 3 illustrates a positional relation between trucks T and the magnetic poles 7 when the yaw angle is large, and part (B) of FIG. 3 illustrates a positional relation between the trucks T and the magnetic poles 7 when the yaw angle is 0.

In the case of the tapered magnetic poles 7, since the magnetic poles 7 fall in the pitch P of the truck 7 not only when the yaw angle is 0 as illustrated in part (B) of FIG. 3 but also when the yaw angle is large as illustrated in part (A) of FIG. 3, the overwriting can be avoided.

However, if the truck pitch is further narrowed, particularly in a patterned medium in which a large number of recording dots are formed on a predetermined arrangement position on the magnetic disk and a magnetic field is applied to the recording dots to record information, the tapered magnetic poles illustrated in FIG. 3 may not obtain a sufficiently strong magnetic field, requiring use of rectangular magnetic poles as illustrated in FIG. 2 after all.

FIG. 4 illustrates a positional relation between trucks and magnetic poles in the patterned medium.

FIG. 4 illustrates magnetic poles 8 whose surface shape facing the magnetic disk is rectangular, and recording dots D to which a magnetic field is applied by the magnetic poles 8 to record information. The trucks T are formed by arrangement of the recording dots D in the vertical direction. The recording dots D have very small areas, but since the recording dots D are magnetically separated from each other, inversion of magnetization does not occur easily, and the recording dots D are strong against heat fluctuation. Therefore, the distance between the trucks T can be narrowed. However, the magnetic field preferably for inversing the magnetization to record information is strong, and if magnetic poles having small widths corresponding to the narrow truck pitch are used and the magnetic poles are tapered as illustrated in FIG. 3, sufficient strength of magnetic field may not be obtained. Therefore, in the patterned medium, it is necessary to apply the rectangular magnetic poles 8 illustrated in FIG. 4.

In FIG. 4 also, the moving direction of the magnetic poles 8 with respect to the truck T is downward as illustrated with the arrow A in the drawing. Like FIG. 2 or 3, part (A) of FIG. 4 illustrates a positional relation between trucks T and the magnetic poles 8 when the yaw angle is large, and part (B) of FIG. 4 illustrates a positional relation between the trucks T and the magnetic poles 8 when the yaw angle is 0.

When the yaw angle is 0 as illustrated in part (B) of FIG. 4, the magnetic poles 8 sequentially pass the series of recording dots D forming one truck T, and the magnetic poles 8 do not pass over recording dots D of adjacent truck T. However, when the yaw angle is large as illustrated in part (A) of FIG. 4, the magnetic poles 8 pass the recording dots D forming the central truck T which is to be recorded, and the leading sides (right lower sides in the drawing) of the magnetic poles 8 pass over the recording dots D of the adjacent truck T. As a result, information is overwritten on the recording dots D of the adjacent truck T.

If the yaw angle is changed, the information recording is affected harmfully as described above. Hence, a technique for restraining the yaw-angle change itself is proposed.

First, there is known a technique in which the arm length is set variable, and a mechanism for driving a steel belt by a roller is disposed on a leading end of the arm to adjust the arm length (see Japanese Laid-open Patent Publication No. 02-29973 for example). By adjusting the arm length using such a mechanism, it is possible to restrain the yaw angle.

Next, there is known a technique in which an arm having a special length longer than usual in accordance with a diameter of a magnetic disk (see U.S. Pat. No. 602,104 for example). By using the arm having the special length, it is possible to restrain the yaw angle by geometric disposition.

However, according to the technique of the Japanese Laid-open Patent Publication No. 02-29973, since the arm is provided at its leading end with the mechanism for adjusting the arm length, the moment of inertia of the arm is increased and a load of the actuator which drives the arm is increased. Thus, there is a problem that high speed movement which satisfies access time of about 10 ms preferably as ability of the HDD (time elapsed until a head moves through ⅓ from inner to outer sides of the magnetic disk) may not be realized. Further, since the primary resonance point of the arm is lowered by the increase of the moment of inertia, there is a problem that even preciseness in positioning of the head realized by the current HDD may not be achieved.

According to the technique of the U.S. Pat. No. 602,104, since an arm which is longer than a normal arm is used, the moment of inertia of the arm is increased. Therefore, the same problem as that of the technique of the Japanese Laid-open Patent Publication No. 02-29973 occurs.

The problems of the HDD have been described above as an example, influence on the reproducing or recording operations caused by the yaw angle or the problem concerning the technique for restraining the yaw angle may occur not only in the HDD but also in a general information storage device employing a rotating disk medium and head movement using the arm.

### SUMMARY

An information storage device includes:

a recording medium shaped like a disk, capable of rotating, and having a disk surface on which information can be stored;

a head that reproduces information from and/or records information into the recording medium by approaching or touching the disk surface of the recording medium;

a fixed portion having a turning axis extending in the same direction as a rotation axis of the recording medium and turning around the turning axis;

a moving portion holding the head and supported by the fixed portion, the moving portion being capable of freely moving relative to the fixed portion in a direction approaching and separating from the rotation axis;

a pin fixed to the moving portion and projecting from the moving portion in a direction intersecting a turning surface of the moving portion; and

a guide having a wall on which the pin abuts and slides as the moving portion turns, the guide restricting an orbit of the pin by a form of the wall to a predetermined orbit that extends to a leading side of the moving portion as the pin moves toward an inner periphery of the recording medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a structure of a hard disk drive (HDD);

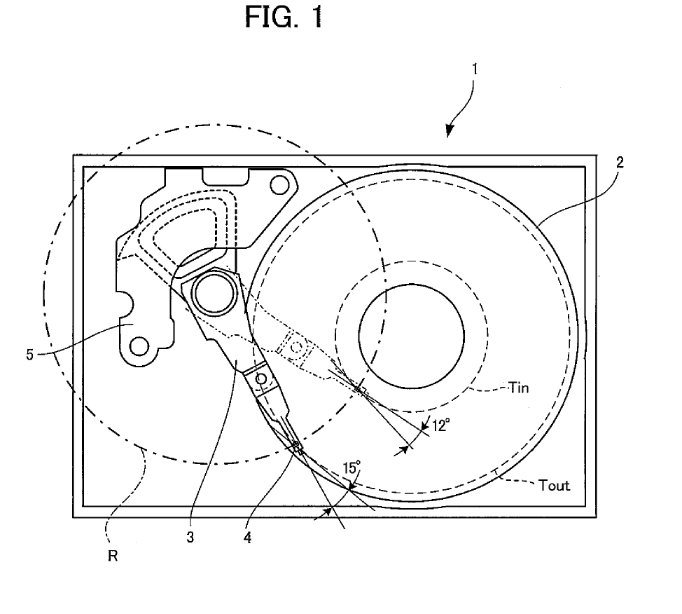

FIG. 2 is a view illustrating a positional relation between trucks and magnetic poles of the magnetic head;

FIG. 3 is a view illustrating a positional relation between trucks and tapered magnetic poles;

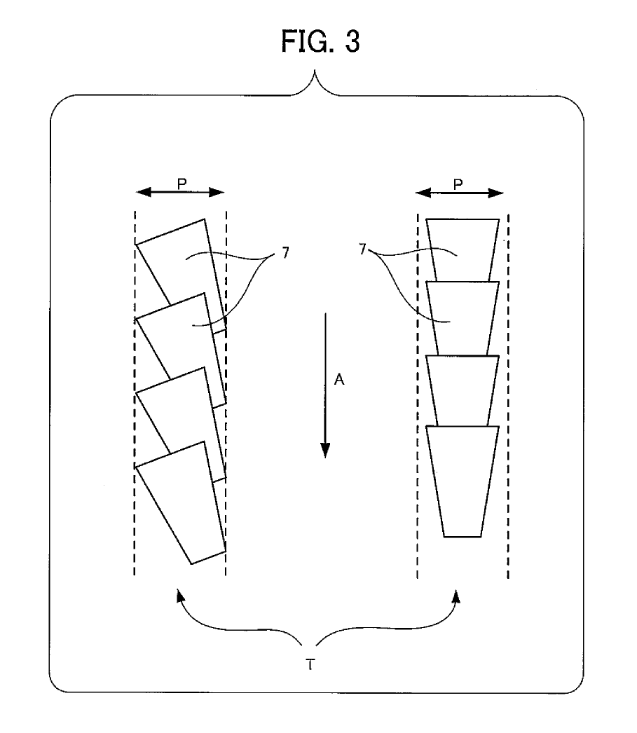

FIG. 4 is a view illustrating a positional relation between trucks and magnetic poles in a patterned medium;

FIG. 5 is a plan view illustrating a hard disk drive (HDD) which corresponds to a concrete first embodiment of an information storage device;

FIG. 6 is a side view illustrating the hard disk drive (HDD) which corresponds to the concrete first embodiment of the information storage device;

FIG. 7 is an enlarged side view of a peripheral portion of a swing arm 20 illustrated in the side view of FIG. 6;

FIG. 8 is a view illustrating a shape and a position of a guide;

FIG. 9 is a view illustrating a state where the magnetic head is located on the innermost peripheral (inner) truck Tin;

FIG. 10 is an enlarged view of peripheries of a moving portion in the first embodiment; and

FIG. 11 is a view illustrating a second embodiment.

### DESCRIPTION OF EMBODIMENT(S)

A concrete first embodiment of the above-explained information storage device of the basic mode will be described with reference to the drawings.

With respect to the information storage device described above in SUMMARY, it is preferable that “plural recording dots are arranged on the disk surface of the recording medium in a rotation direction of the recording medium, information is magnetically recorded on the recording dots, and the head magnetically reproduces information from and/or records information into the recording dots of the recording medium”. According to this preferable aspect, the recording dots can be disposed in high density by restraining the yaw angle change, and an information storage device having high recording density is realized. In the concrete first embodiment which will be described below, a structure of such a typical application mode is employed.

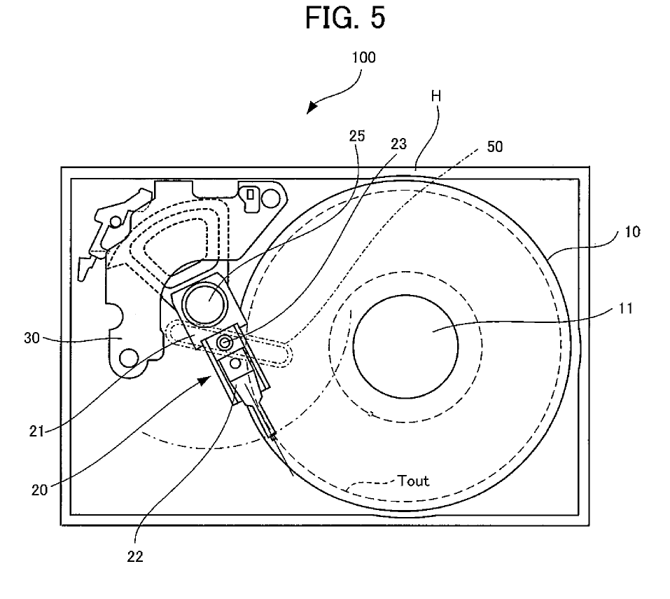

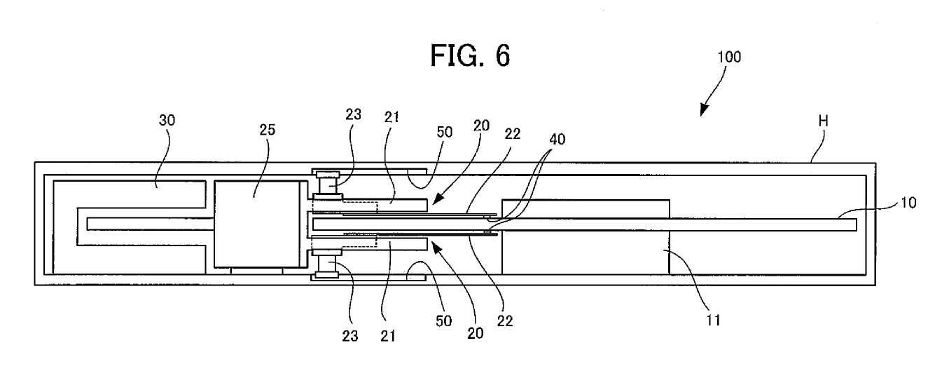

FIG. 5 is a plan view of a hard disk drive (HDD) corresponding to the concrete first embodiment of the information storage device. FIG. 6 is a side view illustrating the HDD. These plan view and side view are views perspective from the top surface and side surface of the main component part of the HDD.

The HDD 100 illustrated in the drawings is assembled into a high device such as a personal computer, and is utilized as information storage means in the high device.

In the Hard Disk Drive 100, a disk-like magnetic disk 10 which is a so-called vertical magnetic recording medium in which information is recorded on the magnetic disk 10 with a magnetic pattern by magnetization in a direction perpendicular to front and back surfaces of the disk, is accommodated in a housing H. The magnetic disk 10 is a so-called bit patterned type magnetic recording medium, and recording dots on which bit information is recorded are formed preliminarily on each location of the front and back surfaces of the magnetic disk 10. The magnetic disk 10 is rotated and driven around a disk axis 11 in the center by a motor. The magnetic disk 10 corresponds to one example of the recording medium in the basic mode and the application mode.

Two swing arms 20 which move along the front and back surfaces of the magnetic disk 10 and an actuator 30 used for driving the swing arms 20 are accommodated in the housing H of the HDD 100.

Each swing arm 20 holds a magnetic head 40 at its leading end. The magnetic head 40 writes and reads information on and from the front and back surfaces of the magnetic disk 10. The swing arm 20 is turnably supported in the housing H by an arm shaft 25. The swing arm 20 turns the arm shaft 25 within a predetermined angle range around a pivot, thereby moving the magnetic head 40 along the front and back surfaces of the magnetic disk 10. The magnetic head corresponds to one example of a head in the information storage device described above in SUMMARY.

A control circuit (not illustrated) which controls the reading and writing operations of information by the magnetic head 40 or the exchange of information with the high device is accommodated in the housing H of the HDD 100.

Details of the structure of the swing arm 20 will be described below.

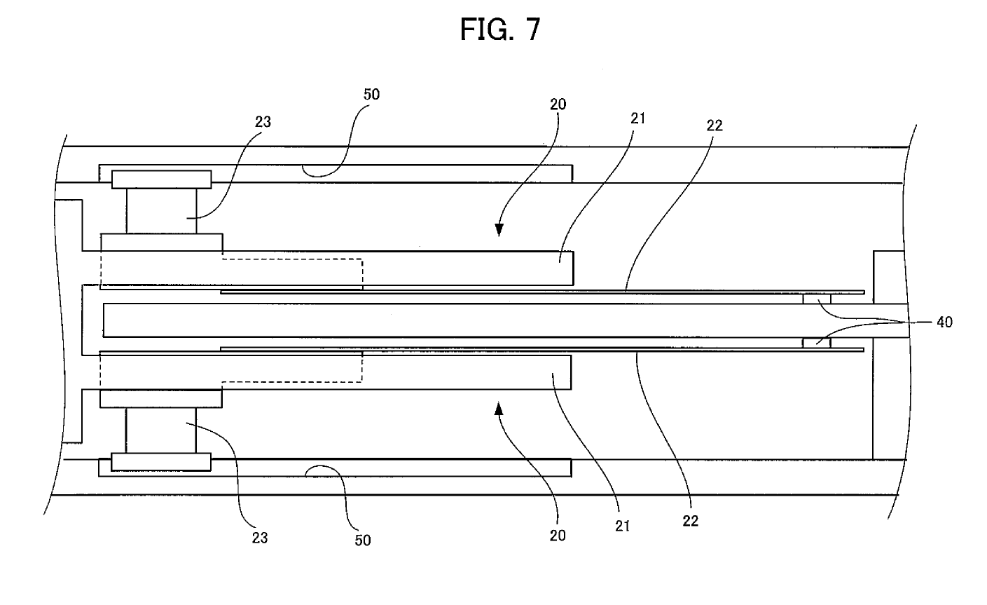

FIG. 7 is an enlarged side view of a peripheral portion of the swing arm 20 illustrated in the side view of FIG. 6. The structure will be described with reference to the enlarged side view and the plan view.

Each swing arm 20 includes a fixed portion 21 and a moving portion 22. A pin 23 projects from the moving portion 22. A head 40 is held by the moving portion 22. The fixed portion 21 is a linear guide which slidably supports the moving portion 22. The moving portion 22 straightly slides with respect to the fixed portion 21, thereby extending and contracting the swing arm 20. A driving part to extend and contract the swing arm 20 is not mounted on the swing arm 20, and only the pin 23 projects from the swing arm 20. Thus, the swing arm 20 is as light as that of the conventional technique. The pin 23 corresponds to one example of the pin in the information storage device described above in SUMMARY.

The pin 23 projecting from the moving portion 22 is fitted into a guide 50 provided in the housing H. The pin 23 traces and moves along an inner wall of the guide 50. As a result, the orbit of the pin 23 is determined by the shape of the inner wall of the guide 50, and the extension and contraction of the swing arm 20 are also determined. The guide 50 corresponds to one example of the guide in the information storage device described above in SUMMARY. To prevent dust from being generated by friction between the pin 23 and the guide 50, the pin 23 is made of resin and the guide 50 is formed by directly carving the metal housing H in the first embodiment. The pin 23 may be made of rubber. Alternatively, the pin 23 may be made of metal or ceramic, while the guide 50 may be made of resin or rubber.

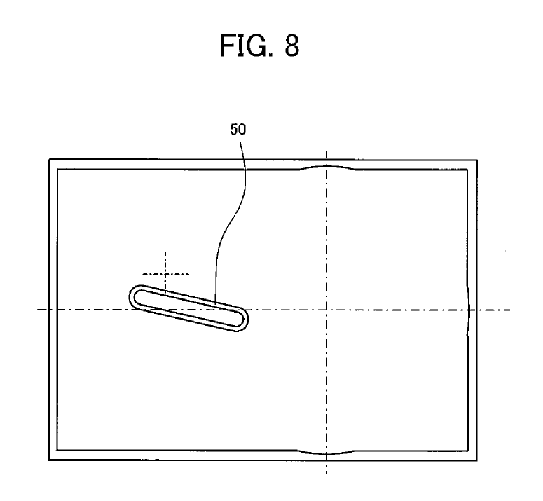

FIG. 8 illustrates the shape and the position of the guide. In the first embodiment, a straight guide 50 is employed. It is easy to design or machine such a straight guide 50.

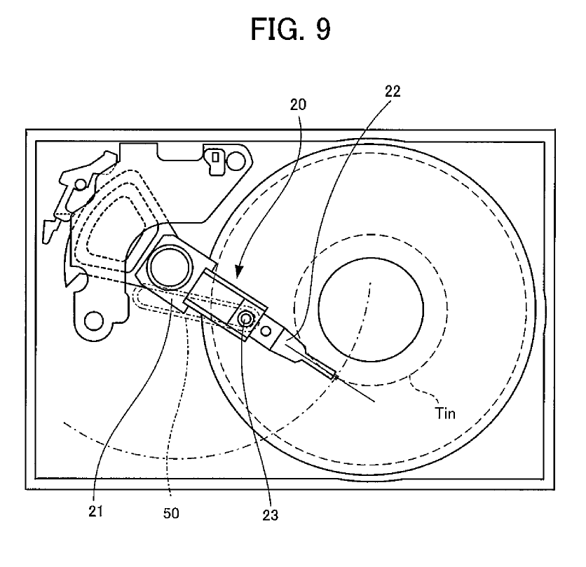

The guide 50 is formed into such a shape that when the swing arm 20 is driven and turned by the actuator 30, the yaw angle is maintained at about 0° by extension and contraction of the swing arm 20. The plan view (FIG. 5) illustrates a state where the swing arm 20 is turned toward the outer periphery of the magnetic disk 10 and the magnetic head is located on the outermost peripheral (outer) truck Tout. In contrast, FIG. 9 illustrates a state where the swing arm 20 is turned toward the inner periphery of the magnetic disk 10 and the magnetic head is located on the innermost peripheral (inner) truck Tin. If FIGS. 5 and 9 are compared with each other, it can be found that when the swing arm 20 is turned toward the inner periphery of the magnetic disk 10, the moving portion 22 of the swing arm 20 slides with respect to the fixed portion 21 and the swing arm 20 extends. The sliding motion of the moving portion 22 is realized by moving the pin 23 along the guide 50.

In any of the states illustrated in FIGS. 5 and 9, the tangent direction of the trucks Tout and Tin and the extension direction of the swing arm 20 (i.e. orientation of the magnetic head) match with each other. At that time, a distance L1 between a pivot center (arm shaft 25) and a center of the magnetic disk 10, a distance R1 between the magnetic head (truck) and the center of the magnetic disk 10, and a distance A1 (variable) between the pivot center (arm shaft 25) and the magnetic head have such a relation that these three distances (sides) L1, R1 and A1 form a right triangle, and the following equation is satisfied:

(A1)2+(R1)2=(L1)2 (1)

The distance A1 between the pivot center (arm shaft 25) and the magnetic head may be said as the length of the swing arm 20, this distance A1 is a sum of a distance A2 between the pin 23 and the magnetic head and a distance A3 between the pin 23 and the pivot center (arm shaft 25), and the following equation is satisfied:

A1=A2+A3 (2)

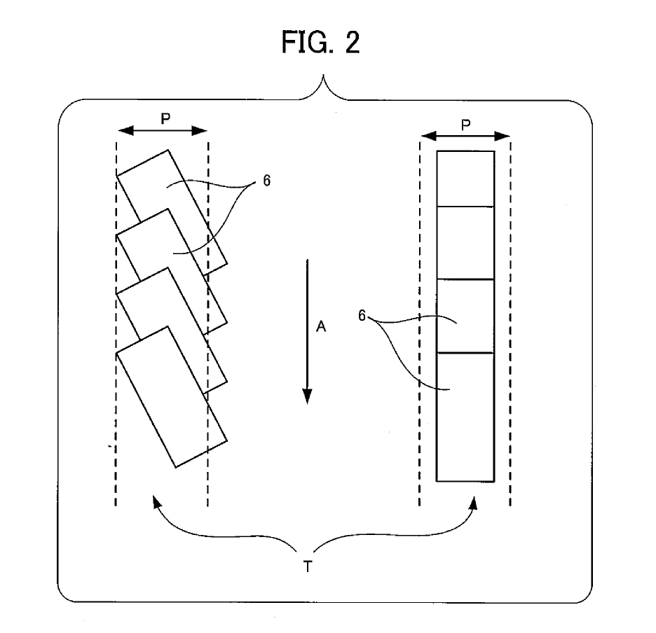

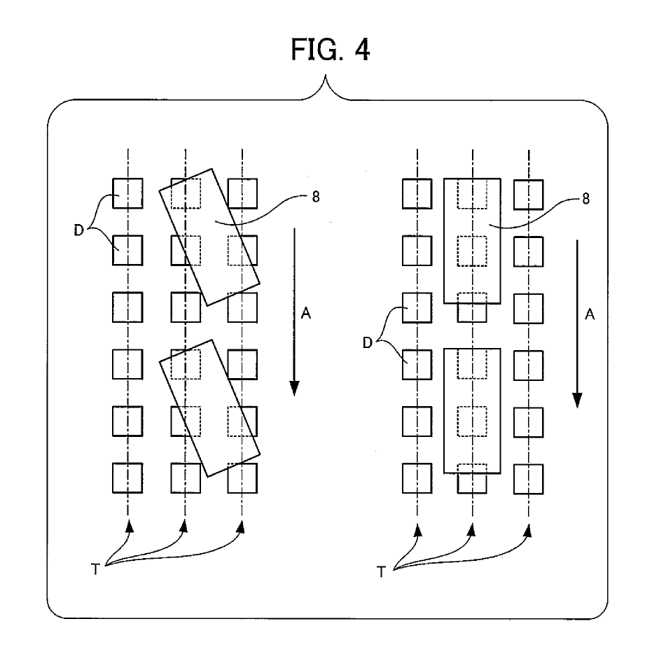

The shape of the guide 50 (i.e., the inner wall) in the first embodiment has such a shape that positions of the pin 23 which satisfies the equations (1) and (2) in the states illustrated in FIGS. 5 and 9 are calculated, and the calculated positions are connected to each other through a straight line. The guide 50 having such a shape guides the pin 23 and the yaw angle can be kept at about 0° as described above. Therefore, according to the first embodiment, the problem caused by the change of the yaw angle explained using FIGS. 2 and 4 is overcome, the narrowing of the truck pitch (distance between the recording dots) can be realized, and it is possible to realize an information storage device of high recording density.

The light-weighted swing arm 20 is extended and contracted by the simple mechanism of the guide 50 and the pin 23. Therefore, according to the first embodiment, high speed movement allowing short access time of about 10 ms required for a HDD is realized, and high positioning precision is also achieved.

The above-described extending and contraction motion of the swing arm 20 is realized by sliding motion of the moving portion 22 with respect to the fixed portion 21, this is preferably at the time of seek operation when the magnetic head moves between the trucks, but at the time of following operation in which the magnetic head reaches a target truck and the magnetic head follows the truck, it is desirable that the moving portion 22 is fixed with respect to the fixed portion 21 to restrain rattle of the moving portion 22 with respect to the fixed portion 21 and to realize the high precision positioning. That is, based on the information storage device described above in SUMMARY, it is preferable that “the fixed portion includes a constraining mechanism capable of holding the moving portion at the fixed portion and releasing the moving portion.” According to this preferable additional aspect, it is possible to lock the moving portion by the constraining mechanism to restrain the rattle of the moving portion with respect to the fixed portion. When the head follows a truck for example, the head can realize precise following of the truck by locking the moving portion.

The first embodiment is also a concrete embodiment of the information storage device with this preferable additional aspect. One example of the constraining mechanism in this preferable additional aspect will be described in detail.

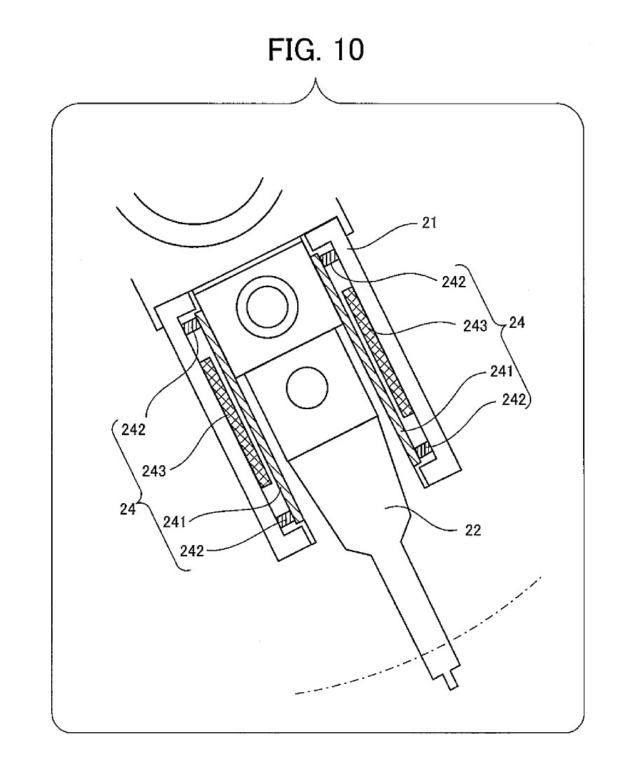

FIG. 10 is an enlarged view of a periphery of the moving portion in the first embodiment.

FIG. 10 again illustrates the fixed portion 21, the moving portion 22, and a fixing mechanism 24 which fixes the moving portion 22 with respect to the fixed portion 21. The fixing mechanism 24 is an example of the constraining mechanism of the information storage device with the above-described preferable additional aspect. The fixing mechanism 24 is provided on the side of the fixed portion 21 so that the weight of the fixing mechanism 24 is brought toward a root side of the swing arm. The fixing mechanism 24 includes a pair of iron fixing bars 241 which nip the moving portion 22 and fix the moving portion 22 to the fixed portion 21, springs 242 which push the fixing bar 241 against the moving portion 22, and electro magnets 243 which suck the fixing bars 241 and release the moving portion 22. If the power sources of the electromagnets 243 are turned ON/OFF, the moving portion 22 is fixed/released, at the time of seek, the electromagnets are turned ON and the moving portion 22 is set free, and at the time of following, the electromagnets are turned OFF and the moving portion 22 is fixed. As a result, it is possible to realize the positioning precision of about 10 to 20 nm at the time of following.

In the above described first embodiment, the guide having the straight linear inner wall is used to make the design and machining of the guide easy, but in respect with the information storage device described in SUMMARY, it is further preferable that “claim 3”. According to this preferable additional aspect, since the angle formed between the orientation of the head and the direction extending from the head to the rotation center of the recording medium is always constant, change of the yaw angle is zero. A second embodiment which is a concrete example of the information storage device with this additional preferable aspect will be described below.

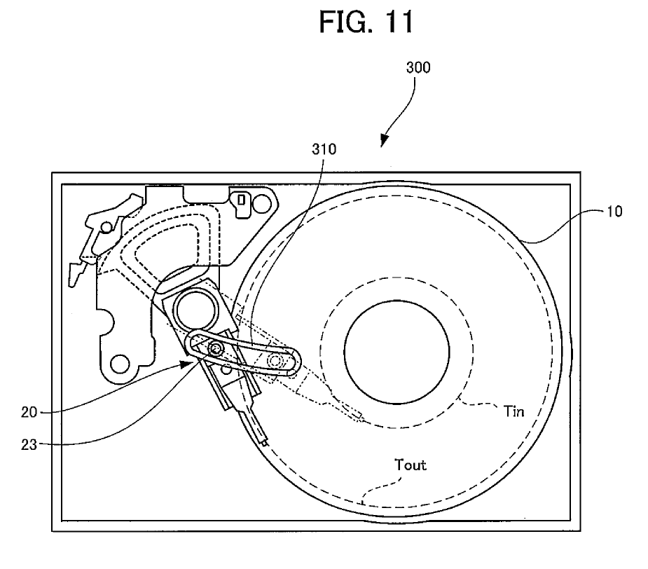

FIG. 11 illustrates the second embodiment.

A HDD 300 of the second embodiment illustrated in FIG. 11 has the same structure as that of the HDD 100 in the first embodiment illustrated in FIG. 5 except that a shape of a guide 310 (i.e., a shape of its inner wall) is curve.

In the curved guide 310 provided in the HDD 300, each position of the pin 23 which satisfy the equations (1) and (2) are calculated in each angle in a range from an angle of the swing arm 20 where the magnetic head is located on the outermost (outer) peripheral truck Tout of the magnetic disk to an angle of the swing arm 20 where the magnetic head is located on the innermost (inner) peripheral truck Tin, and a curve which connects the calculated positions to each other is obtained. According to the guide 310 having the obtained curve shape, the change in the yaw angle is zero, the yaw angle zero is realized in all positions on the magnetic disk, and ideal yaw angle correction is realized.

In each of the concrete embodiments, the bit patterned type HDD is described as an example. However, a continuous medium type HDD or a heat assist type HDD may also be employed as a concrete embodiment of the information storage device described above in SUMMARY, and the present invention can also be applied to an information storage device which employs, for example, an optical medium or magneto-optical medium other than the HDD.

Although the pin traces the inner wall of the guide is exemplified in each of the concrete embodiments, the wall of the guide of the information storage device described above in SUMMARY is not necessarily the inner wall. As a concrete example of the guide in the information storage device described above in SUMMARY, the pin may trace an outer wall of a projecting guide.

According to the information storage device described above in SUMMARY, the pin traces the wall of the guide so that the moving path of the head is corrected from the arc shape, and the change of the yaw angle is restrained. The movement of the moving portion with respect to the fixed portion is realized by the turning motion of the fixed portion around the turning axis and the restriction of the pin orbit by the guide. Therefore, the structures of the moving portion and the fixed portion are simple, and the weight of the device can sufficiently be reduced.

As described above, according to the above-described embodiments, it is possible to restrain the change of the yaw angle with a light-weighted structure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information storage device comprising:
a recording medium shaped like a disk, capable of rotating, and having a disk surface on which information can be stored;
a head that reproduces information from and/or records information into the recording medium by approaching or touching the disk surface of the recording medium;
a fixed portion having a turning axis extending in the same direction as a rotation axis of the recording medium and turning around the turning axis;
a moving portion holding the head and supported by the fixed portion, the moving portion being capable of freely moving relative to the fixed portion in a direction approaching and separating from the rotation axis;
a pin fixed to the moving portion and projecting from the moving portion in a direction intersecting a turning surface of the moving portion; and
a guide having a wall on which the pin abuts and slides as the moving portion turns, the guide restricting an orbit of the pin by a form of the wall to a predetermined orbit that extends to a leading side of the moving portion as the pin moves toward an inner periphery of the recording medium.

2. The information storage device according to claim 1, wherein the fixed portion includes a constraining mechanism capable of holding the moving portion at the fixed portion and releasing the moving portion.

3. The information storage device according to claim 1, wherein a plurality of recording dots are arranged on the disk surface of the recording medium in a rotation direction of the recording medium, information is magnetically recorded on the recording dots, and the head magnetically reproduces information from and/or records information into the recording dots of the recording medium.

4. The information storage device according to claim 2, wherein a plurality of recording dots are arranged on the disk surface of the recording medium in a rotation direction of the recording medium, information is magnetically recorded on the recording dots, and the head magnetically reproduces information from and/or records information into the recording dots of the recording medium.

5. The information storage device according to claim 1, wherein the guide has, as the wall, a curved wall which leads the pin such that an angle formed between an orientation of the head and a direction from the head to a rotation center of the recording medium remains constant.

6. The information storage device according to claim 2, wherein the guide has, as the wall, a curved wall which leads the pin such that an angle formed between an orientation of the head and a direction from the head to a rotation center of the recording medium remains constant.

7. The information storage device according to claim 3, wherein the guide has, as the wall, a curved wall which leads the pin such that an angle formed between an orientation of the head and a direction from the head to a rotation center of the recording medium remains constant.
